(19) United States
(12) Patent Application Publication
(10) Pub. No.: US 2021/0374907 A1
(43) Pub. Date: Dec. 2, 2021

(54) MODULAR TRAINING OF IMAGE PROCESSING DEEP NEURAL NETWORK PIPELINE WITH ADAPTOR INTEGRATION

(71) Applicant: KYOCERA DOCUMENT SOLUTIONS INC., OSAKA (JP)

(72) Inventor: Dongpei Su, Palos Verdes, CA (US)

(21) Appl. No.: 16/886,295

(22) Filed: May 28, 2020

(51) Int. Cl. G06T 3/40; G06T 5/00; G06N 3/08; G06N 3/04

(52) U.S. Cl. CPC G06T 3/4046; G06T 5/002; G06T 3/4053; G06T 2207/20081; G06N 3/0454; G06T 2207/20084; G06N 3/08

(57) ABSTRACT

Methods and systems for training and utilizing an artificial neural network (ANN) are provided. In an example method, a computing device can receive an image pair, where a first image of the image pair includes a training image and a second image of the image pair includes a ground truth image. The computing device could utilize a trained de-noise ANN to determine a de-noised representation of the first image. The computing device could then indirectly training an adaptor ANN by at least applying the adaptor ANN on the de-noised representation to produce an adapted representation for the first image; determining, using a trained super resolution ANN, a high resolution image from the adapted representation, and computationally updating weights of the adaptor ANN based on a loss function that comprises a difference between the high resolution image and the second image.

### BACKGROUND

Image compression is used to reduce the memory footprint of an image. Many types of image compression formats exist, including the JPEG format and the Portable Network Graphic (PNG) format, among others.

During some compression processes, a quality factor could be used to specify an extent of compression on an original image. For example, if a higher quality factor is specified, then the compression process may retain more information about the original image. On the other hand, if a lower quality factor is specified, then the compression process may retain less information about the original image.

If too much information is lost during a compression process, the resulting compressed image may exhibit “blocky” artifacts. For example, textured regions with high-frequency content, such as grass or clouds, may appear blurry in the compressed image. Further, sharp edges, such as a roof of a house and a guardrail, may exhibit ringing in the compressed image.

A computing device could perform various image enhancement techniques to increase the quality of a compressed image. For example, a computing device may clean (e.g., perform de-blocking, ringing noise removal, etc.) the compressed image. The computing device could also apply a super resolution engine to increase the resolution of the compressed image. The computing device could perform these image enhancements before printing the compressed image or at another time.

### SUMMARY

Herein described are techniques and apparatus generally related to utilizing artificial neural networks (ANNs) and machine learning (ML) to improve image processing.

Accordingly, in a first example embodiment, a computer-implemented method is provided. A computing device receives an image pair. A first image of the image pair includes a respective initial training image and a second image of the image pair includes a respective ground truth training image. The computing device utilizes a trained de-noise ANN to determine a de-noised representation of the first image of the image pair. The computing device indirectly trains an adaptor ANN. The indirect training involves applying the adaptor ANN on the de-noised representation to produce an adapted representation for the first image of the image pair. The indirect training further involves determining, using a trained super resolution ANN, a high resolution image from the adapted representation. The indirect training additionally includes computationally updating weights of the adaptor ANN based on a loss function that comprises a difference between the high resolution image and the second image for the image pair. The computing device provides the trained adaptor ANN, the trained de-noise ANN, and the trained super resolution ANN.

In a second example embodiment, a computing device is provided. The computing device includes one or more processors; and non-transitory data storage. The non-transitory data storage stores at least computer-readable instructions that, when executed by the one or more processors, cause the computing device to perform tasks in accordance with the first example embodiment.

In a third example embodiment, an article of manufacture is provided. The article of manufacture includes non-transitory data storage storing at least computer-readable instructions that, when executed by one or more processors of a computing device, cause the computing device to perform tasks in accordance with the first example embodiment.

In a fourth example embodiment, a computing system may include various means for carrying out each of the operations of the first example embodiment.

In a fifth example embodiment, a computer-implemented method is provided. A computing device receives an image pair. A first image of the image pair comprises a respective initial training image and a second image of the image pair comprises a respective ground truth training image. The computing device indirectly trains a de-noise ANN. The indirect training includes applying the de-noise ANN on the first image of the image pair to produce a de-noised version of the first image. The indirect training also includes determining, using a trained super resolution ANN, an extracted feature map for the de-noised version of the first image. The indirect training further includes determining, using the trained super resolution ANN, an extracted feature map for the second image. The indirect training yet further includes computationally updating weights of the de-noise ANN based on a loss function that comprises (i) a difference between the second image and the de-noised version of the first image and (ii) a difference between the extracted feature map for the de-noised version of the first image and the extracted feature map for the second image. The computing device provides the trained de-noise ANN.

In a sixth example embodiment, a computing device is provided. The computing device includes one or more processors; and non-transitory data storage. The non-transitory data storage stores at least computer-readable instructions that, when executed by the one or more processors, cause the computing device to perform tasks in accordance with the fifth example embodiment.

In a seventh example embodiment, an article of manufacture is provided. The article of manufacture includes non-transitory data storage storing at least computer-readable instructions that, when executed by one or more processors of a computing device, cause the computing device to perform tasks in accordance with the fifth example embodiment.

In an eighth example embodiment, a computing system may include various means for carrying out each of the operations of the fifth example embodiment.

Other aspects, embodiments, and implementations will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

FIG. 1 is a diagram of a printing network, according to example embodiments.

FIG. 2 is a block diagram illustrating a computing device, according to example embodiments.

FIG. 3 is a diagram of a supervised learning pipeline, according to example embodiments.

FIG. 4A depicts a de-noise artificial neural network (ANN), according to example embodiments.

FIG. 4B depicts operations of the de-noise ANN of FIG. 4A, according to example embodiments.

FIG. 5A depicts a super resolution ANN, according to example embodiments.

FIG. 5B depicts operations of the super resolution ANN of FIG. 5A, according to example embodiments.

FIG. 6 is a diagram of an image processing pipeline, according to example embodiments.

FIG. 7A depicts a modified de-noise ANN, according to example embodiments.

FIG. 7B depicts a modified super resolution ANN, according to example embodiments.

FIG. 8 is a diagram of a process, according to example embodiments.

FIG. 9 shows a flowchart for a method, according to example embodiments.

FIG. 10 depicts various outputs of a de-noise ANN, according to example embodiments.

FIG. 11 depicts a modified super resolution ANN, according to example embodiments.

FIG. 12 is a diagram of a process, according to example embodiments.

FIG. 13 shows a flowchart for a method, according to example embodiments.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

I. Introduction

An artificial neural network (ANN) can be trained with a large number of images (e.g., hundreds, thousands, or even more images) to perform various types of image enhancements to improve the overall quality of the images. Example images may include images with one or more quality issues; e.g., low contrast, non-uniform illumination, low resolution, blocky artifacts, etc. These images can be obtained from various sources and/or applications. The images can be provided to train the ANN on how to perform various types of image enhancements, such as de-noising, super resolution, histogram equalizations, and/or other image enhancement techniques.

The ANN can include a collection of “nodes” or connected units of computation that can loosely model computation. Connected nodes of the ANN can transmit signals between each other; such as numerical values. Each node can receive one or more input signals, weight the input signals, and combine the weighted input signals to generate one or more output signals. A weight of an input signal can be a numerical value that increases or decreases an effect of its input signal on the output signal.

The ANN can have one or more “layers” or groups of nodes including, but not limited to, one or more layers of input nodes, nodes arranged in one or more hidden layers, and one or more layers of output nodes. Intermediate layers that are between an input layer and an output layer can be termed “hidden layers” as these in-between layers are not visible/hidden from entities outside of the ANN. Other example ANN layers include but are limited to, input layers and output layers that respectively receive inputs from and provide outputs to entities outside of the ANN convolutional layers which convolve (e.g., downsample) their inputs, activation (e.g., RELU) layers which apply an activation function to their inputs, pooling layers which combine their inputs, and fully-connected layers where each node in the fully-connected layer receives all outputs from a previous layer as its inputs.

An ANN can be trained to learn one or more tasks. During training, the ANN can adjust weights within nodes based on a loss function that provides feedback on task performance by the ANN. Once the ANN is deemed to be trained, the trained ANN can be termed a “model” and can generate output predictions based on corresponding inputs. For example, if an input includes an image with many blocky artifacts, the ANN can perform an image enhancement technique on the input image and generate an output that includes a representation of the input image without the blocky artifacts. As another example, if an input is a low resolution image, the ANN can perform an image enhancement technique on the input image and generate an output that includes a high resolution representation of the input image. Other examples are also possible.

Training an ANN can involve supervised learning. Supervised learning involves having the ANN infer a function to perform one or more tasks from labeled training data consisting of one or more training data items. In some examples, a training data item includes at least an input image and a desired output image that can act to “label” or identify a result of the ANN's execution of the function operating on the input image. The desired output image of the training data item can be termed as a “ground truth” image.

Multiple trained ANNs could be combined together to form various types of image processing pipelines. Input images could proceed through such image processing pipelines in a sequential manner. For example, an input image could be provided to a first ANN in an image processing pipeline. The first ANN could perform a first image enhancement technique to produce an enhanced version of the input image. Then, the enhanced version of the input image could be provided to a second ANN in the image processing pipeline. The second ANN could perform a second image enhancement technique on the enhanced version of the input image. This pattern could continue on and on, using various types of ANNs.

A problem, however, with such sequential image processing pipelines is that ANNs in the pipeline could have been separately trained. That is, each ANN in the pipeline may have been trained with its own training dataset, and therefore may have its own noise assumptions, optimal resolutions and/or signal conditions. Thus, because each ANN merely has knowledge of its own task and no knowledge of the “global” task being performed by the image processing pipeline, quality degradation issues might ensue. For example, if a first ANN in an image processing pipeline produces a small error when performing a first image enhancement technique, that error could be amplified by a second ANN in the pipeline.

In theory, one solution to address this problem is to train a single ANN to perform the functions of an entire image processing pipeline. In other words, instead of having a first ANN perform a first image enhancement technique and a second ANN perform a second image enhancement technique, a single trained ANN could be trained to perform both the first and second image enhancement techniques. Yet, this theoretical solution has its own issues. Since the single ANN must learn the several image processing techniques that are part of the pipeline, the model complexity and dimensionality of the single ANN could increase exponentially. This could cause the single ANN to experience severe overfitting. Further, it may be prohibitively expensive to prepare enough training data to cover all edge cases that would be experienced by the single ANN. Because of these and other reasons, training a single ANN to perform the functions of an entire image processing pipeline becomes impractical.

The herein described techniques can be used to solve this technical problem. In particular, the present disclosure provides for an adaptor ANN that resides between a first ANN and a second ANN in an image processing pipeline. The first ANN could be trained to perform a first image enhancement technique (e.g., image de-noising) and the second ANN could be trained to perform a second image enhancement technique (e.g., super resolution). On the other hand, the adaptor ANN could be initially untrained.

A computing device could indirectly train the adaptor ANN, for instance, by applying the first ANN to an input training image, applying the adaptor ANN to the output of the first ANN, applying the second ANN to the output of the adaptor ANN, and then computationally updating the weights of the adaptor ANN based on a comparison between the output from the second ANN and a ground truth image. The ground truth image may be a representation of the input training image upon undergoing the first image enhancement technique. As used herein, “indirect training” refers to a training process in which the immediate output from a machine learning model is not the only output used to computationally update the machine learning model. Instead, during “indirect training”, the output from another machine learning model may be used to computationally update the machine learning model. For instance, in the example above, the immediate output from the adaptor ANN is not used to computationally update the adaptor ANN. Rather, the output from the second ANN is used to calculate the loss and computationally update the adaptor ANN.

Using such an adaptor ANN in an image processing pipeline provides numerous benefits. For one, when compared to image processing pipelines implemented by a single ANN, the adaptor ANN is much less complex to train and therefore may exhibit substantially less overfitting. Further, when compared to image processing pipelines implemented by two individually trained ANNs, the adaptor ANN allows for the two ANNs to gain knowledge about the “global” task being performed by the image processing pipeline. Accordingly, the described techniques allow for the construction of large image processing pipelines that do not incur too much performance loss.

Further, the herein described techniques also provide for leveraging image processing pipelines to improve the image processing results for a given ANN. For instance, an image processing ANN could be trained to remove/reduce pixel level artifacts in an input image. In some cases, such training involves minimizing a loss function, such as mean square error (MSE), between pixels in an input image and pixels in a ground truth image. However, in practice, such pixel-wise loss functions perform poorly when faced with high frequency details, such as texture, in an input image. In particular, using a pixel-wise MSE may encourage an ANN to calculate pixel-wise averages and discourage the ANN from maintaining any extreme pixel values. Because extreme pixel values generally capture the rich textures in an image, using a pixel-wise MSE may result in overly-smoothed, dull looking images that do not have rich textures.

The herein described techniques can be used to solve this technical problem. In particular, an image processing pipeline may include a first ANN and a second ANN. The first ANN may be configured to perform a first image enhancement technique and the second ANN may be configured to perform a second image enhancement technique. The first image enhancement technique may primarily extract and enhance low level features (e.g., dots, lines, edges) from an input image. An example first image enhancement technique may include image de-noising. The second image enhancement technique may primarily extract and enhance mid-level features (e.g., shapes, textures, perhaps objects) from an input image. An example first image enhancement technique may include super resolution. Further, the first ANN may be untrained, whereas the second ANN may be trained.

A computing device could indirectly train the first ANN, for instance, by applying the first ANN to an input training image, applying the second ANN to the output of the first ANN, and then computationally updating the weights of the first ANN based on a loss function that includes both: (i) a comparison between output from the first ANN and a ground truth image and (ii) a comparison between the output of the second ANN and a modified version of the ground truth image. The ground truth image may be a noise free representation of the input training image or may be a representation of the input training image upon undergoing the first image enhancement technique. The modified version of the ground truth image may be a representation of the ground truth image upon undergoing the second image enhancement technique.

The disclosed approach advantageously leverages the second ANN—which has the ability to understand and extract mid-level features—in order to train the first ANN—which has the has the ability extract low level features. Using the guidance of the higher level features of the second ANN, the first ANN could learn how to better differentiate between pixels containing noise and pixels containing relevant, mid-level features. This could result in improved textural output from first ANN, for example, output images without over-smoothing. Other advantages are also possible.

II. Example Printing Networks and Computing Devices

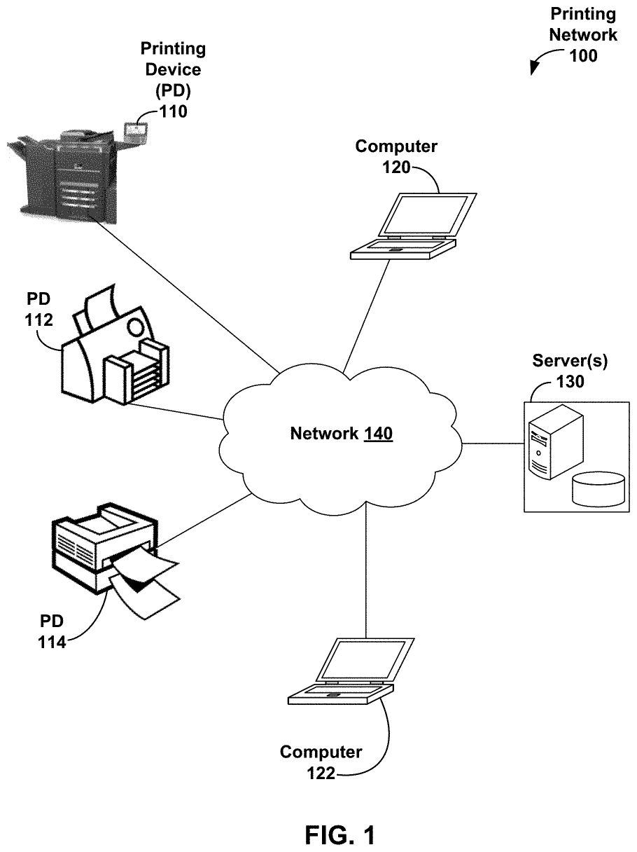

FIG. 1 is a diagram illustrating printing network 100, according to example embodiments. Printing network 100 includes printing devices (PDs) 110, 112, 114, computers 120, 122, and one or more servers 130, all interconnected using network 140. In some examples, printing network 100 can have more, fewer, and/or different types of computing devices, servers, and/or printing devices than indicated in FIG. 1.

Printing devices 110, 112, 114 can include devices configured to scan, print, copy, e-mail, account for, communicate and/or otherwise process documents and/or files that are originally available either on paper or electronically. After processing by one or more of printing devices 110, 112, 114, the documents and/or files can be subsequently available either on paper or electronically, as requested. That is, printing devices 110, 112, 114 can process a paper document PD or electronic document ED by at least: creating an electronic document ED1 representing the contents of PD (e.g., scan PD to create ED1), making one or more paper copies of PD, printing one or more copies of ED and/or ED1 on one or more types of paper, make one or more electronic copies of ED and/or ED1, change a format of ED and/or ED1 (e.g., perform OCR scanning, convert a file format used to store ED and/or ED1), maintain remotely-accessible storage (e.g., a document box) enabling other devices than printing devices 110, 112, 114 to use/access ED and/or ED1, and/or communicate the contents of ED and/or ED1 to/from another device.

A document box can be storage allocated to an entity (e.g., a user, an administrator, a company, another type of entity) on a printing device, print server, or another device so the entity can keep and maintain documents, files, and/or other data. In some embodiments, the document box can be accompanied by and/or include storage for personal data, such as address book and/or device accounting storage. The document box, address book, and device accounting storage can store one or more documents, files, personal data, and/or other data, such as contacts, usage and usage limits.

In some embodiments, printing devices 110, 112, 114 can perform other tasks and/or other processing as well. Printing devices 110, 112, 114 can include products from various manufacturers with variations in color, speed, computing power, functionality, network connectivity, and/or other features.

In example embodiments, some or all printing devices 110, 112, 114 can be connected to network 140 through one or more, possibly different, network protocols. Data can be transmitted between printing devices 110, 112, 114, computers 120, 122, and server(s) 130 over wired and/or wireless links between computers, computing devices, printing devices, servers and network 140. The format of each respective data transmission between devices in printing network 100 can include one or more of a variety of different formats including: text formats, image formats, extensible mark-up language (XML), Simple Network Maintenance Protocol (SNMP) formats, database tables, a flat file format, or another format.

Communications between the computers, computing devices, servers, and printing devices can include: computers 120, 122, and/or server(s) 130 sending data for print jobs and/or print job portions for printing to printing devices 110, 112, 114 and printing devices 110, 112, 114 sending alert, status, error, device information, colorant-usage information, maintenance-event information, and/or other messages to computers 120, 122, and/or server(s) 130 to inform other devices about colorant-usage, maintenance, error, and/or other conditions of the printing devices; e.g., idle, printing, sleeping, paper jam, low or out of paper, low or out of toner/ink, etc. Other communications between computers 120, 122, and/or server(s) 130 are possible as well, such as, but not limited to, requests to render images using radial gradient coloring and related responses to the requests, are possible as well.

Computers 120, 122 can create, obtain, update, display, and/or delete data (and perhaps related software) for configurations of printing network 100. Example data for configurations of printing network 100, includes, but is not limited to: data for configuring devices in printing network 100; e.g., data for printing devices 110, 112, 114, data for configuring network protocols (e.g., File Transfer Protocol (FTP), HyperText Transfer Protocol (HTTP), Java Message Service (JMS), Kyocera Page Description Language (KPDL™), Private Communications Technology (PCT), Adobe® Page Description Format (PDF), Simple Object Access Protocol (SOAP), Short Message Service (SMS), Simple Message Transfer Protocol (SMTP), SNMP, Transfer Control Protocol/Internet Protocol (TCP/IP), User Datagram Protocol (UDP), Lightweight Directory Access Protocol (LDAP), Message Queue (MQ), and/or other protocols), access-management related data for clients and/or servers; (e.g., passwords, signatures, credentials, certificates, subscriptions, licenses, and/or tokens related to accessing part or all of the functionality of network 140 and/or cloud-based services, software and/or solutions) and data for customizing, configuring and managing applications on devices/servers of printing network 100. In particular, computers 120, 122 can provide displays related to maintaining printing devices, including displays related to colorant usage for printing devices and/or predictions related to colorant usage, where the printing devices can include but are not limited to printing devices 110, 112, 114.

One or more servers 130 can store, update, delete, retrieve, and provide functionality for learning patterns, trends, and/or features about data related to printing network 100, particularly related to printing devices, such as printing devices 110, 112, 114. Based on the learned patterns, trends, and/or features, server(s) 130 can generate outputs, such as predictions about the printing devices including but not limited to predictions of colorant usage by the printing devices. The data stored on server(s) 130 can include device information, colorant-usage information, maintenance-event information, and/or other information related to devices related to printing network 100. The stored data can be retrieved from server(s) 130 in response to a received query (or queries) requesting information about specific device(s), colorant usage, maintenance events, and/or other information.

In some embodiments, server(s) 130 can provide additional services as well (or instead), such as services related to some or all of the functionality for one or more document solutions and managed print services; e.g., functionality for accounting and maintenance of solutions and services, functionality for document workflows, such as processing forms, hard-copy signatures, client authentication/access functions, user interface functionality, local and/or remote network based storage management involving devices in printing network 100. For example, server(s) 130 additionally can provide functionality related to a print server. A print server can process jobs (e.g., spool job-related data, route jobs, provide user and/or server-related accounting for jobs, verify/enforce authentication and authorization rules related to jobs) and store data related to printing devices of printing network 100. The jobs processed by a print server can include, but are not limited to, print jobs/printing requests, communicating documents, files, and/or related data (e.g., data in e-mails, SMS messages, etc.), document and file-related requests (e.g., creating, formatting, scanning, reformatting, converting, accessing, updating and/or deleting one or more documents and files), jobs for document workflow, and/or processing information about errors/complaints about the printing device (e.g., creating, reviewing, updating, assigning, reassigning, communicating, and/or deleting trouble tickets related to errors/complaints about printing (and perhaps other) devices 110, 112, 114. The data can include data used in processing jobs (e.g., spooled data for print jobs, files for file-related requests, etc.), access-management related data, primary identification characteristics and/or model-dependent information about printing devices served by server(s) 130 and perhaps other data.

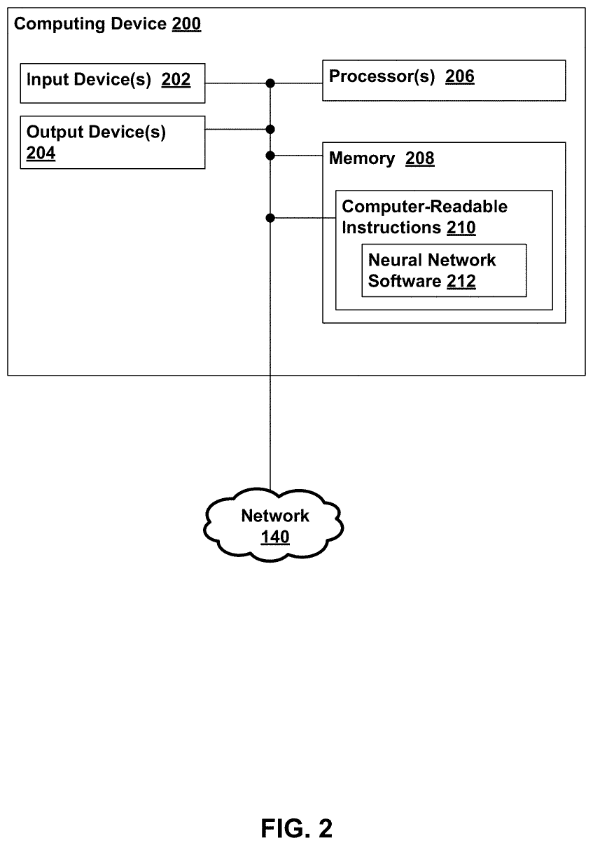

FIG. 2 is a schematic block diagram illustrating computing device 200, according to example embodiments. Computing device 200 can include one or more input devices 202, one or more output devices 204, one or more processors 206, and memory 208. In some embodiments, computing device 200 can be configured to perform one or more herein-described functions of and/or functions related to: e.g., some or all of at least the functionality described in the context of an artificial neural network, a convolutional neural network, a recurrent neural network, artificial neural networks 400, 500, 700, 750, 1100, pipelines 300 and 600, processes 800 and 1200, and methods 900 and 1300.

Input devices 202 can include user input devices, network input devices, sensors, and/or other types of input devices. For example, input devices 202 can include user input devices such as a touch screen, a keyboard, a keypad, a computer mouse, a track ball, a joystick, a camera, a voice recognition module, and/or other similar devices. Network input devices can include wired network receivers and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network, such as wired portions of network 140, and/or wireless network receivers and/or transceivers, such as a Bluetooth™ transceiver, a Zigbee® transceiver, a Wi-Fi™ transceiver, a WiMAX™ transceiver, a wireless wide-area network (WWAN) transceiver and/or other similar types of wireless transceivers configurable to communicate via a wireless network, such as wireless portions of network 140. Sensors can include devices configured to measure conditions in an environment of computing device 200 and provide data about that environment, such data including, but not limited to, location data, velocity (speed, direction) data, acceleration data, and other data about the environment for computing device 200. Example sensors include, but are not limited to, Global Positioning System (GPS) sensor(s), location sensors(s), gyroscope(s), accelerometer(s), magnetometer(s), camera(s), light sensor(s), infrared sensor(s), and microphone(s). Other input devices 202 are possible as well.

Output devices 204 can include user display devices, audible output devices, network output devices, and/or other types of output devices. User display devices can include one or more printing components, liquid crystal displays (LCD), light emitting diodes (LEDs), lasers, displays using digital light processing (DLP) technology, cathode ray tubes (CRT), light bulbs, and/or other similar devices. Audible output devices can include a speaker, speaker jack, audio output port, audio output device, headphones, earphones, and/or other similar devices. Network output devices can include wired network transmitters and/or transceivers, such as an Ethernet transceiver, a USB transceiver, or similar transceiver configurable to communicate via a twisted pair wire, a coaxial cable, a fiber-optic link, or a similar physical connection to a wireline network, such as wired portions of network 140, and/or wireless network transmitters and/or transceivers, such as a Bluetooth™ transceiver, a Zigbee® transceiver, a Wi-Fi™ transceiver, a WiMAX™ transceiver, a WWAN transceiver and/or other similar types of wireless transceivers configurable to communicate via a wireless network, such as wireless portions of network 140. Other types of output devices can include, but are not limited to, vibration devices, haptic feedback devices, and non-visible light emission devices; e.g., devices that emit infra-red or ultra-violet light. Other output devices 204 are possible as well.

Processors 206 can include one or more general purpose processors, central processing units (CPUs), CPU cores, and/or one or more special purpose processors (e.g., graphics processing units (GPUs), digital signal processors (DSPs), field programmable gated arrays (FPGAs), application specific integrated circuits (ASICs), additional graphics-related circuitry/processors, etc.). Processors 206 can be configured to execute computer-readable instructions 210 that are contained in memory 208 and/or other instructions as described herein.

Memory 208 can include one or more computer-readable storage media configured to store data and/or instructions that can be read and/or accessed by at least one of processors 206. The one or more computer-readable storage media can include one or more volatile and/or non-volatile storage components, such as optical, magnetic, organic or other memory or disc storage, which can be integrated in whole or in part with at least one of processors 206. The computer-readable storage media can include one or more components that store data for short periods of time like register memories, processor caches, and/or random access memories (RAM). The computer-readable storage media can include non-transitory computer readable media that stores program code and/or data for longer periods of time, such as secondary or persistent long term storage; for example, read only memory (ROM), optical or magnetic disks, compact-disc read only memory (CD-ROM). In some embodiments, memory 208 can be implemented using a single physical device (e.g., one optical, magnetic, organic or other memory or disk storage unit), while in other embodiments, memory 208 can be implemented using two or more physical devices.

In particular, memory 208 can store computer-readable instructions 210 that, when executed by processor(s) 206, can cause a computing device to perform functions, such as but not limited to, some or all of at least the herein-described functionality of devices, networks, methods, diagrams, images, equations, and/or scenarios. In some embodiments, computer-readable instructions 210 can include at least instructions for neural network software 212. Neural network software 212 can include software and/or firmware for providing neural-network-related and/or machine-learning-algorithm-related functionality; e.g., some or all of at least the functionality described in the context of an artificial neural network, a convolutional neural network, a recurrent neural network, machine learning algorithm 340, predictive model 360, networks 400, 500, 700, 750, 1100, 1150, pipelines 600, 800, 1200, and methods 900, 1300.

III. Example Neural Networks

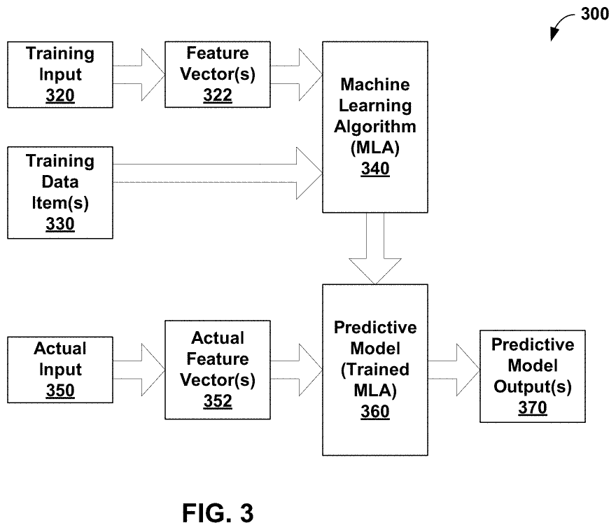

FIG. 3 is a diagram of a supervised learning pipeline 300, according to example embodiments. Supervised learning pipeline 300 includes training input 320, one or more feature vectors 322, one or more training data items 330, machine learning algorithm 340, actual input 350, one or more actual feature vectors 352, predictive model 360, and one or more predictive model outputs 370. Part or all of supervised learning pipeline 300 can be implemented by executing software for part or all of supervised learning pipeline 300 on one or more processing devices and/or by using other circuitry (e.g., specialized hardware for carrying out part or all of supervised learning pipeline 300).

In operation, supervised learning pipeline 300 can involve two phases: a training phase and a prediction phase. The training phase can involve machine learning algorithm 340 learning one or more tasks. The prediction phase can involve predictive model 360, which can be a trained version of machine learning algorithm 340, making predictions to accomplish the one or more tasks. In some examples, machine learning algorithm 340 and/or predictive model 360 can include, but are not limited, to one or more: artificial neural networks (ANNs), deep neural networks, convolutional neural networks (CNNs), recurrent neural networks, support vector machines (SVMs), Bayesian networks, genetic algorithms, linear classifiers, non-linear classifiers, algorithms based on kernel methods, logistic regression algorithms, linear discriminant analysis algorithms, and/or principal components analysis algorithms.

During the training phase of supervised learning pipeline 300, training input 320 can be processed to determine one or more feature vectors 322. In some examples, training input 320 can be preprocessed; e.g., for image de-noising tasks or super resolution tasks.

In some examples, some or all of training input 320 includes one or more images. The images could include, for example, images collected by a printing device provider that exhibit known quality issues, such as resolution related issues or noise related issues. In some cases, training input 320 can include images collected from web scrapers configured to retrieve images exhibiting known quality issues from public image datasets or the Internet. In some cases, training input 320 can contain several “normal” images that exhibit no known quality issues.

Feature vector(s) 322 can be provided to machine learning algorithm 340 to learn one or more tasks. After performing the one or more tasks, machine learning algorithm 340 can generate one or more outputs based on feature vector(s) 322 and perhaps training input 320. During training, training data item(s) 330 can be used to make an assessment of the output(s) of machine learning algorithm 340 for accuracy and machine learning algorithm 340 can be updated based on this assessment. Training of machine learning algorithm 340 can continue until machine learning algorithm 340 is considered to be trained to perform the one or more tasks. Once trained, machine learning algorithm 340 can be considered to be a predictive model, such as predictive model 360.

During the prediction phase of supervised learning pipeline 300, actual input 350 can be processed to generate one or more actual feature vectors 352. In some examples, some or all of actual input 350 includes one or more actual images. Actual input 350 can be provided to predictive model 360 via actual feature vector(s) 352. Predictive model 360 can generate one or more outputs, such as predictions, based on actual input 350. The output(s) of predictive model 360 can then be provided as predictive model output(s) 370. In some examples, predictive model 360 can receive a request to make one or more predictions, and reception of the request can trigger predictive model 360 to generate predictive model output(s) 370 based on actual input 350 and/or actual feature vector(s) 352. In some of these examples, the request can include and/or refer to actual input 350.

In some examples, machine learning algorithm 340 can be trained on one or more training computing devices and predictive model 360 can be executed on the same training computing device(s). In some examples, machine learning algorithm 340 can be trained on the training computing device(s). Then, after training, now-trained machine learning algorithm 340 can be communicated as predictive model 360 from the training computing device(s) to one or more other computing devices that can execute predictive model 360 to operate on actual input 350 to generate predictive model output(s) 370.

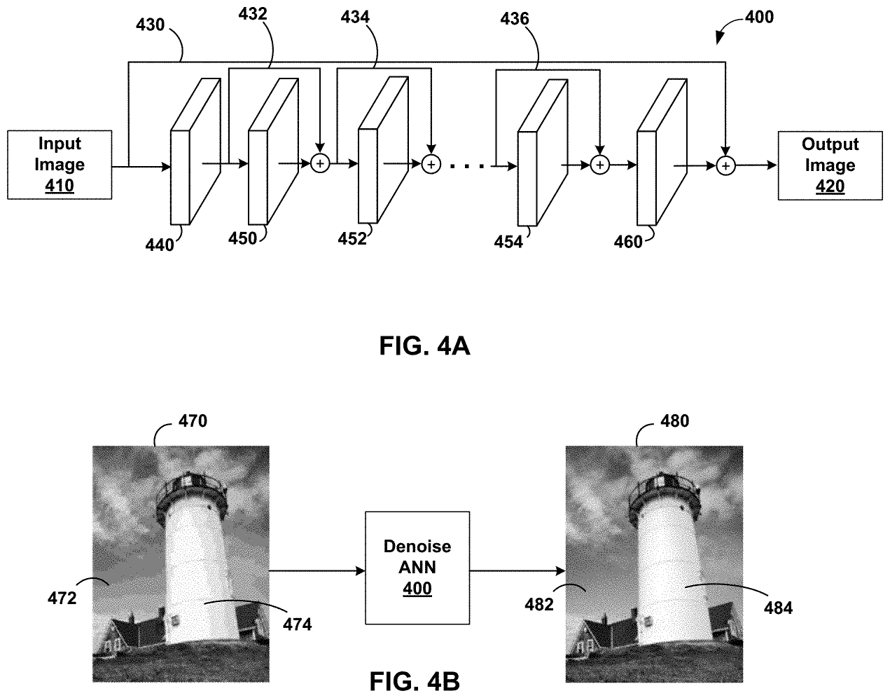

FIG. 4A depicts de-noise artificial neural network (ANN) 400, according to example embodiments. De-noise ANN 400 could be a trained ANN (e.g., a trained machine learning algorithm 340) configured to receive a noisy input image 410 and correspondingly generate output image 420, which may be a de-noised version of noisy input image 410. In example embodiments, de-noise ANN 400 could be trained using supervised learning pipeline 300, as described above with reference to FIG. 3.

In various examples, de-noise ANN 400 could take the form of a convolutional neural network (CNN) and could perform convolution, activation, pooling, or inference tasks using a combination of convolution layers, activation layers, pooling layers, and fully connected layers. For instance, de-noise ANN 400 could include an input layer 440, intermediate block layers 450, 452, and 454, and an output layer 460. In example implementations, input layer 440 could include one or more convolution layers and/or one or more activation layers, input layer 440 could also include one or more convolution layers and/or one or more activation layers, and each of the intermediate block layers 450, 452, and 454 could include several convolution layers each followed by an activation layer.

Generally speaking, a convolution layer includes one or more filters used to filter respective inputs. Each filter works over a subset of an input image or volume. For example, suppose an input to convolutional layer was a 100×100 pixel image in CMYK format (Z=4). As such, the convolution layer receives the 100'100×4 volume of pixels as an input volume and acts to convolve a 3×3×4 filter over the 100×100×4 volume. To do this, the convolution layer slides the filter across the width and height of the input volume and compute dot products between the entries of the filter and the input at each position that the filter is on the input volume. As the convolution layer slides the filter, the filter generates a 2-dimensional feature map that gives the responses of that filter at every spatial position of the input volume. Multiple such filters could be used in a given convolution layer to produce multiple 2-dimensional feature maps. Further, multiple 2-dimensional feature maps could be combined to form a 3-dimensional feature map, which may have larger dimensions than the input layers and the output layers of the given CNN.

The output of the convolution layer (e.g., the feature maps mentioned above) can be provided as an input to an activation layer. The activation layer may be applied to determine which values of the feature map are to be provided to a subsequent layer. More generally, the activation function can determine whether the output of the convolution layer (e.g., the feature map) is to be provided to a subsequent layer. Activation layers could utilize sigmoid/logistic activation functions, hyperbolic tangent activation functions, or rectified linear unit (ReLU) functions, among other possibilities.

In example embodiments, the number of intermediate block layers in de-noise ANN 400 may vary (e.g., as indicated by the ellipsis). For instance, the number of intermediate block layers may depend on the size of the input images provided to de-noise ANN 400 (e.g., the size of input image 410) or the number of training examples available to de-noise ANN 400, among other possibilities.

Further, de-noise ANN 400 could include one or more of skip connections, such as skip connection 430, 432, 434, and 436. Each skip connection connects the output of one layer with the input of an earlier layer. For example, skip connection 430 could be used to concatenate/sum the result from output layer 460 with input image 410 so as to yield output image 420. As another example, skip connection 432 is used to concatenate/sum the output from intermediate block layer 450 with the output from input layer 440. The result from skip connection 432 could then be passed to intermediate block layer 452 as well as skip connection 434.

Notably, the architecture of de-noise ANN 400 is not intended to be limiting with respect to example embodiments or techniques described herein. In other embodiments, de-noise ANN 400 may contain fewer layers, more layers, or different layers than those depicted in FIG. 4A.

FIG. 4B depicts an operation using de-noise ANN 400, in accordance with example embodiments. As shown, de-noise ANN 400 could receive input image 470 and responsively generate output image 480, which is a de-noised representation of input image 470. In particular, when comparing input image 470 to output image 480, notice how regions 472 and 474 in input image 470 contain blocky noise, whereas the corresponding regions 482 and 484 in output image 480 do not contain blocky noise. In line with the discussion above, the blocky noise in input image 470 could be due to information loss during an image compression process.

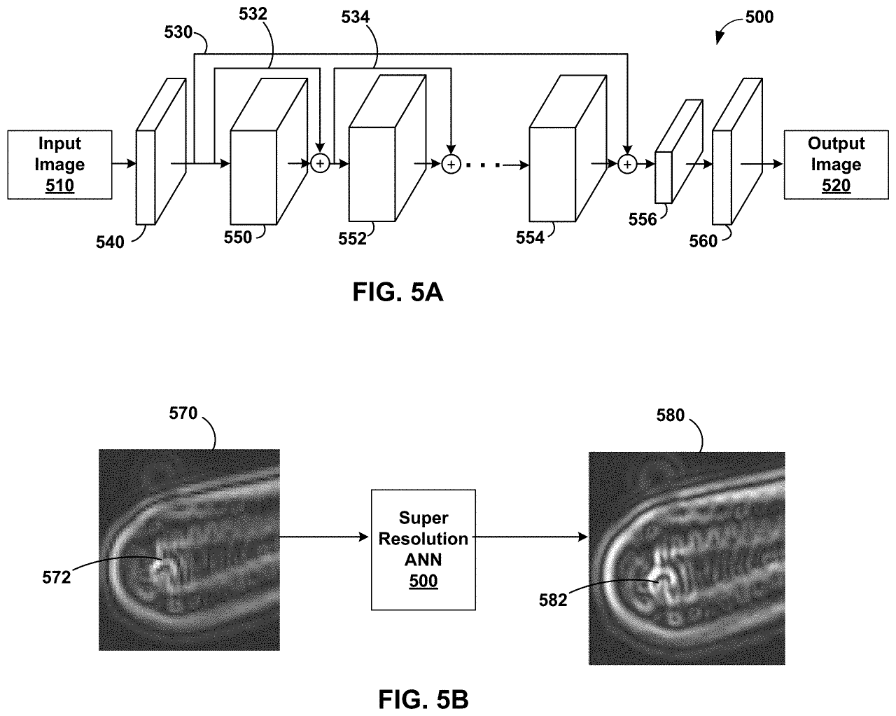

FIG. 5A depicts super resolution ANN 500, according to example embodiments. Super resolution ANN 500 could be a trained ANN (e.g., a trained machine learning algorithm 340) configured to receive a low resolution input image 510 and correspondingly generate output image 520, which may be a high resolution version of low resolution input image 510. In example embodiments, super resolution ANN 500 could be trained using supervised learning pipeline 300, as described above with reference to FIG. 3.

Like de-noise ANN 400, super resolution ANN 500 take the form of a CNN and could perform convolution, activation, up-sampling, upscaling, deconvolution, or inference tasks using a combination of convolution layers, activation layers, up-sampling layers, up-scaling layers, deconvolutional layers, and fully connected layers. For instance, super resolution ANN 500 could include an input layer 540, intermediate block layers 550, 552, and 554, up-sampling block layer 556, and output layer 560. In example embodiments, input layer 540 could include one or more convolution layers and/or one or more activation layers, output layer 560 could also include one or more convolution layers and/or one or more activation layers, up-sampling block layer 556 could include several up-sampling convolution layers and/or one or more activation layers, and each of the intermediate block layers 550, 552, and 554 could include several convolution layers and several activation layers.

In example embodiments, the number of intermediate block layers in super resolution ANN 500 may vary (e.g., as indicated by the ellipsis). For instance, the number of intermediate block layers may depend on the size of the input images provided to super resolution ANN 500 (e.g., the size of input image 510) or the number of training examples available to super resolution ANN 500, among other possibilities.

Also like de-noise ANN 400, super resolution ANN 500 could include one or more of skip connections, such as skip connection 530, 532, and 534. Each skip connection connects the output of one layer with the input of an earlier layer. For example, skip connection 530 is used to concatenate/sum the output from intermediate block layer 554 with the output from input layer 540. The result from skip connection 530 could then be passed to up-sampling layer 556. Further, each of intermediate block layers 550, 552, and 554 may contain one or more skip connections between the layers therein.

Notably, the architecture of super resolution ANN 500 is not intended to be limiting with respect to example embodiments or techniques described herein. In other embodiments, super resolution ANN 500 may contain fewer layers, more layers, or different layers than those depicted in FIG. 5A.

FIG. 5B depicts an operation using super resolution ANN 500, in accordance with example embodiments. As shown, super resolution ANN 500 could receive input image 570 and responsively generate output image 580, which is a high resolution representation of input image 570. In particular, when comparing input image 570 to output image 580, notice how region 572 in input image 570 contains a low resolution feature, whereas the corresponding region 582 in output image 580 does not contain the low resolution feature. The low resolution feature in input image 570 could be due to information loss during an image compression process.

IV. Example Image Processing Pipelines with Adaptor Networks

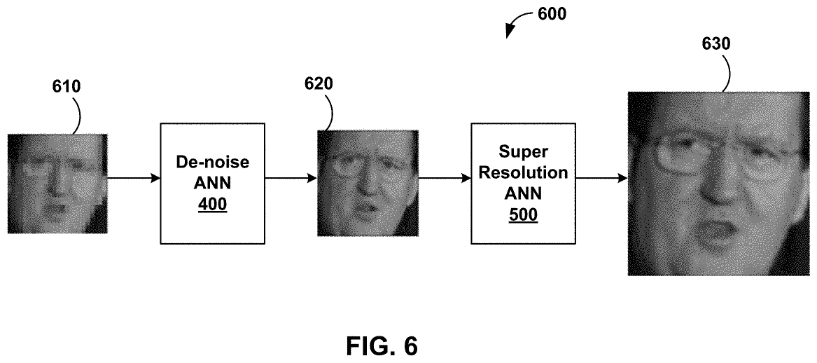

FIG. 6 is a diagram of image processing pipeline 600, according to example embodiments. In examples, image processing pipeline 600 includes de-noise ANN 400 and super resolution ANN, both of which were described in reference to FIG. 4A and FIG. 5A. Part or all of image processing pipeline 600 can be implemented by executing software for part or all of image processing pipeline 600 on one or more processing devices and/or by using other circuitry (e.g., specialized hardware for carrying out part or all of image processing pipeline 600). In some examples, image processing pipeline 600 may be deemed a “sequential” image processing pipeline.

Image processing pipeline 600 may begin with input image 610 being provided to de-noise ANN 400. In line with the discussion above, input image 610 may correspond to a noisy, low resolution image. In some examples, input image 610 could result from an image compression process.

Using the operations described above in reference to FIG. 4A and FIG. 4B, de-noise ANN 400 could receive and process input image 610 to produce de-noised image 620, which may be a de-noised representation of input image 610. De-noise ANN 400 could then provide de-noised image 620 to super resolution ANN 500.

Using the operations described above in reference to FIG. 5A and FIG. 5B, super resolution ANN 500 could receive and process de-noised image 620 to produce output image 630, which may be a high resolution representation of de-noised image 620.

In line with the discussion above, a problem, however, with image processing pipeline 600 is that ANNs in the pipeline may have been separately trained. For example, de-noise ANN 400 may be separately trained from super resolution ANN 500. This separate training may cause each ANN in image processing pipeline 600 to maintain knowledge only of its own task and no knowledge of the “global” task being performed by the pipeline. As a result, quality degradation issues might ensue. For example, if de-noise ANN 400 produces a small error when processing input image 610, that error could be amplified when super resolution ANN 500 processes the output from de-noise ANN 400.

In theory, one solution to address this problem is to train a single ANN to perform the operations of image processing pipeline 600. For example, instead of having de-noise ANN 400 and super resolution ANN 500 as part of image processing pipeline 600, a single trained ANN could be trained to perform operations of image processing pipeline 600. Yet, this theoretical solution has its own issues. Since the single ANN must learn the several image processing techniques that are part of image processing pipeline 600 (e.g., the processing techniques used by de-noise ANN 400 and the processing techniques used by super resolution ANN 500), the model complexity and dimensionality of the single ANN could increase exponentially. This could cause the single ANN to experience severe overfitting. Further, it may be prohibitively expensive to prepare enough training data to cover all edge cases that would be experienced by the single ANN. Because of these and other reasons, training a single ANN to perform the functions of image processing pipeline 600 becomes impractical.

To address this technical problem, the present disclosure provides for an adaptor ANN that resides between de-noise ANN 400 and super resolution ANN 500 in image processing pipeline 600. The adaptor ANN may be trained to learn a mapping between de-noise ANN 400 and super resolution ANN 500 so as to allow the output from de-noise ANN 400 to be transformed in a manner that takes into account the output from super resolution ANN 500. Such a mapping could advantageously reduce or possibly remove quality degradation issues for image processing pipeline 600.

Much like de-noise ANN 400 and super resolution ANN 500, the disclosed adaptor ANN could take the form of a CNN and could perform convolution, activation, pooling, or inference tasks using a combination of convolution layers, activation layers, pooling layers, and fully connected layers. The number of layers in the adaptor ANN and the dimensions of those layers may vary. In some embodiments, the number of layers in the adaptor ANN and the dimensions of those layers depend on the size and number of layers in de-noise ANN 400 (or modified de-noise ANN 700 described below). Additionally and/or alternatively, the number of layers in the adaptor ANN and the dimensions of those layers depend on the size and number of layers in super resolution ANN 500 (or modified super resolution ANN 750 described below). In some examples, the adaptor ANN could include one or more inception sub-networks.

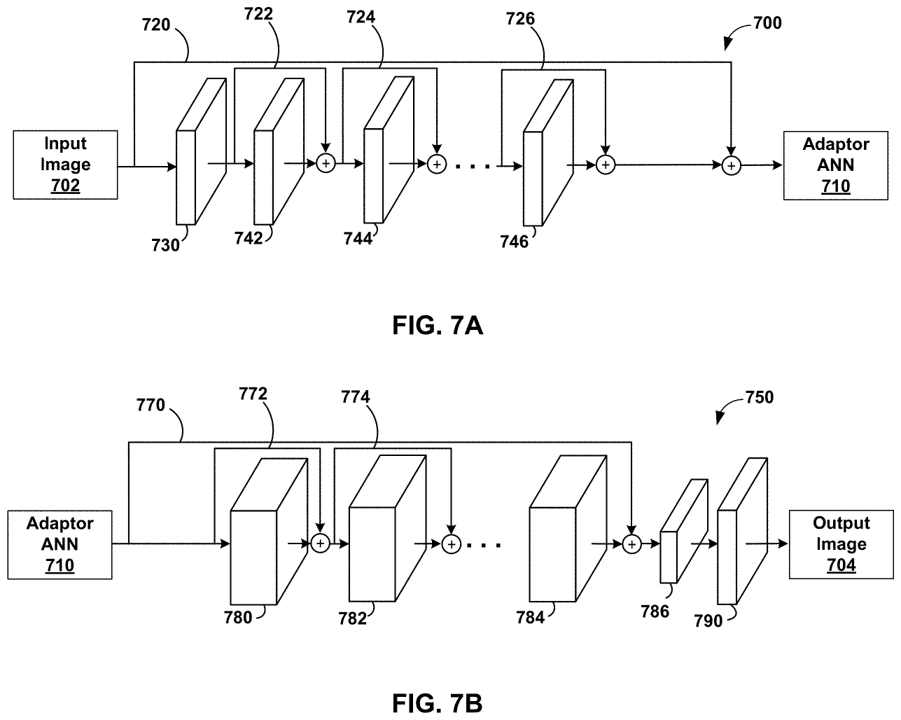

In examples, various structural modifications may be made to de-noise ANN 400 and super resolution ANN 500 to facilitate the integration of the adaptor ANN into image processing pipeline 600. Such modifications will now be described with respect to FIGS. 7A and 7B.

FIG. 7A depicts modified de-noise ANN 700, according to example embodiments. Modified de-noise ANN 700 could be a trained ANN (e.g., a trained machine learning algorithm 340) configured to receive noisy input image 702 and correspondingly output a de-noised representation of the noisy input image 702. Modified de-noise ANN 700 may then provide the de-noised representation to adaptor ANN 710. In example embodiments, modified de-noise ANN 700 may be a modified version of de-noise ANN 400 as discussed with respect to FIG. 4A. For example, after training de-noise ANN 400 (e.g., perhaps using supervised learning pipeline 300) various modifications could be made to the structure of de-noise ANN 400 so as to yield modified de-noise ANN 700. Such modifications are discussed in detail below.

As shown in FIG. 7A, modified de-noise ANN 700 includes an input layer 730, intermediate block layers 742, 744, and 746, and various skip connections, including skip connections 720, 722, 724, and 726. In example implementations, input layer 730 may take the form of input layer 440, intermediate block layers 742, 744, and 746 could respectively take the form of intermediate block layers 450, 452, 454, and skip connections 720, 722, 724, and 726 could respectively take the form of skip connections 430, 432, 434, and 436.

Notice, however, that unlike de-noise ANN 400, modified de-noise ANN 700 does not include an output layer (e.g., does not include output layer 460). As a result, the output of modified de-noise ANN 700 may be a feature map generated by intermediate block layer 746. In line with the discussion above, the feature map generated intermediate block layer 746 may have more dimensions (i.e., width*height*depth) than output layer 460, and thus may be a more feature rich representation of input image 702 than the output from output layer 460 would be. When compared to de-noise ANN 400, the more feature rich outputs of modified de-noise ANN 700 advantageously reduce information loss on images being passed to adaptor ANN 710.

To facilitate the integration of adaptor ANN 710 with modified de-noise ANN 700, in example embodiments, adaptor ANN 710 may contain an input layer that has the same dimensions as the feature map generated by intermediate block layer 746. Further, in some implementations, the feature map generated by intermediate block layer 746 may be modified before being passed to adaptor ANN 710. For example, as shown in FIG. 7A, skip connection 720 allows input image 702 to be summed or concatenated with the feature map generated by intermediate block layer 746 before being passed adaptor ANN 710.

In some embodiments, the output of modified de-noise ANN 700 may be a feature map generated from another intermediate block layer. For example, the output of modified de-noise ANN 700 may be a feature map generated by intermediate block layer 744 or intermediate block layer 742.

In an example operating using modified de-noise ANN 700, input image 702 is provided to input layer 730. Upon receiving input image 702, input layer 730 may perform a series of convolutions, activations, and/or other operations to produce a feature map. The feature map could then be passed to intermediate block layer 742 (and perhaps passed to other layers depending on the placement of skip connections 720, 722, 724, and 726). Intermediate block layer 742 may perform computations (e.g., a series of convolutions, activations, pooling, and/or other operations) on the input received from input layer 730 and provide its result to intermediate block layer 744. Intermediate block layer 744 may perform computations on the input from intermediate block layer 742 and provide its result to intermediate block layer 746. Intermediate block layer 746 may perform computations on the input from intermediate block layer 744 and may provide its resulting feature map (perhaps after adding input image 702 via skip connection 720) to adaptor ANN 710.

FIG. 7B depicts modified super resolution ANN 750, according to example embodiments. Modified super resolution ANN 750 could be a trained ANN (e.g., a trained machine learning algorithm 340) configured to receive an input representation from adaptor ANN 710 and correspondingly output a high resolution output image 704, which may be a high resolution representation of the input representation received from adaptor ANN 710. In example embodiments, modified super resolution ANN 750 may be a modified version of super resolution ANN 500, as discussed with respect to FIG. 5A. For example, after super resolution ANN 500 is trained (e.g., perhaps using supervised learning pipeline 300) various modifications could be made to the structure of super resolution ANN 500 so as to yield modified super resolution ANN 750. Such modifications are discussed in detail below

As shown in FIG. 7B, modified super resolution ANN 750 includes intermediate block layers 780, 782, and 784, up-sampling layer 786, output layer 790, and various skip connections, including skip connections 770, 772, and 774. In example implementations, intermediate block layers 780, 782, and 784 could respectively take the form of intermediate block layers 550, 552, and 554, up-sampling layer 786 could take the form of up-sampling layer 556, output layer 790 could take the form of output layer 560, and skip connections 770, 772, and 774 could respectively take the form of skip connections 530, 532, and 534.

Notice, however, that unlike super resolution ANN 500, modified super resolution ANN 750 does not include an input layer (e.g., does not include input layer 540). As a result, the input into modified super resolution ANN 750 may be passed directly to intermediate block layer 780.

To facilitate the integration of adaptor ANN 710 with modified super resolution ANN 750, in example embodiments, adaptor ANN 710 may contain an output layer that has the same dimensions as intermediate block layer 780. In some cases, that same dimension may be greater than the dimensions of input layer 540. Further, in alternative embodiments, the input into modified super resolution ANN 750 may be provided to another intermediate block layer. For example, the input into modified super resolution ANN 750 may be provided into intermediate block layer 782 or 784.

In an example operating using modified super resolution ANN 750, adaptor ANN 710 provides an input representation (e.g., a feature map) to intermediate block layer 780. Intermediate block layer 780 may perform computations (e.g., a series of convolutions, activations, pooling, and/or other operations) on the input representation and provide its result to intermediate block layer 782. Intermediate block layer 782 may perform computations on the input from intermediate block layer 780 and provide its result to intermediate block layer 784. Intermediate block layer 784 may perform computations on the input from intermediate block layer 782 and provide its result to up-sampling layer 786. Up-sampling layer 786 may perform up-sampling operations (e.g., decreasing the amount of dimensions) on the input from intermediate block layer 784 and may provide its result to output layer 790. And finally, output layer 790 may process the input from up-sampling layer 786 and produce output image 704, which may be a high resolution image representation of the input representation provided by adaptor ANN 710.

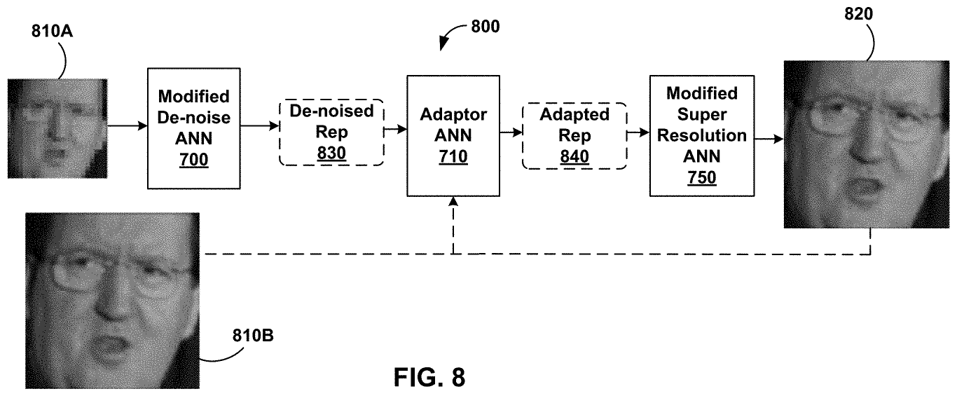

FIG. 8 is a diagram of process 800 for indirectly training adaptor ANN 710, according to example embodiments. Process 800 includes modified de-noise ANN 700, adaptor ANN 710, and modified super resolution ANN 750. Part or all of process 800 can be implemented by executing software for part or all of process 800 on one or more processing devices and/or by using other circuitry (e.g., specialized hardware for carrying out part or all of process 800). Further, part or all of process 800 could be implemented by a printing device, such as printing device 110 described in reference to FIG. 1.

Process 800 may begin when training image 810A is passed to modified de-noise ANN 700. In line with the discussion above, training image 810A may be an input image containing at least some noisy features. Training image 810A may be associated with ground truth image 810B, which may be a high resolution and de-noised version of training image 810A. As such, training image 810A and ground truth image 810B form an “image pair”.

Upon receiving training image 810A, modified de-noise ANN 700 may determine de-noised representation 830 for training image 810A. As discussed above, de-noised representation 830 may be an output from intermediate layer 746 of modified de-noise ANN 700.

After de-noised representation 830 is determined, process 800 could continue with modified de-noise ANN 700 providing de-noised representation 830 to adaptor ANN 710. Upon receiving de-noised representation 830, adaptor ANN 710 may determine adapted representation 840 from de-noised representation 830. Adaptor ANN 710 could then provide adapted representation 840 to modified super resolution ANN 750. In line with the discussion, adaptor ANN 710 may provide adapted representation 840 to intermediate layer 780 of modified super resolution ANN 750.

Upon receiving adapted representation 840, modified super resolution ANN 750 may determine output image 820. In line with the discussion above, output image 820 may be a high resolution representation of adapted representation 840.

After output image 820 is determined, process 800 may continue by computationally updating weights of adaptor ANN 710 based on a loss function that includes a difference between output image 820 and ground truth image 810B. In some implementations, the difference between output image 820 and ground truth image 810B is pixel-wise difference. That is, pixels in output image 820 may be compared to corresponding pixels in ground truth image 810B to determine the extent to which the weights in adaptor ANN 710 need to be updated.

Process 800 may continue for a plurality of image pairs. In some embodiments, process 800 may continue until the occurrence of one or more training termination criteria at adaptor ANN 710. The training termination criteria can include, but are not limited to, when the error determined by the loss function is less than a predetermined threshold value, the change in the error determined by the loss function is sufficiently small between consecutive iterations of training, or a pre-determined maximum number of iterations has been reached, among other possibilities.

Once adaptor ANN 710 is deemed to be trained (e.g., after one or more training termination criteria have been satisfied), the adaptor ANN 710 can be termed a “model” and can generate output predictions based on corresponding inputs. At this point, in some implementations, a second process could be initiated to “fine tune” the weights of modified de-noise ANN 700, adaptor ANN 710, and modified super resolution ANN 750. In this second process, a second training image could be provided to modified de-noise ANN 700. The second training image may be part of an image pair that includes a second ground truth image. Similar to process 800, modified de-noise ANN 700 may perform computations on the second training image and provide its result to adaptor ANN 710; adaptor ANN 710 may perform computations on the input from modified de-noise ANN 700 and provide its result to modified super resolution ANN 750; and modified super resolution ANN 750 may perform computations on the input from adaptor ANN 710. However, unlike process 800, instead of merely computationally updating the weights of adaptor ANN 710 based on a difference between the output of modified super resolution ANN 750 and the second ground truth image, the second process may computationally update the weights of each of modified de-noise ANN 700, adaptor ANN 710, and modified super resolution ANN 750 based on the difference between the output of modified super resolution ANN 750 and the second ground truth image.

Further, in some embodiments, after training is complete (e.g., after process 800 is complete or after the second process described above is complete), modified de-noise ANN 700, adaptor ANN 710, and modified super resolution ANN 750 may each be provided to a printing device, such as printing device 110 described in reference to FIG. 1. Upon receiving the trained ANNs, the printing device could use the trained ANNs to process an image during one or more printing processes. Alternatively, rather than being provided to the printing device, de-noise ANN 700, adaptor ANN 710, and modified super resolution ANN 750 may be provided to a remote computing device commutatively coupled to the printing device. In such a scenario, the printing device may communicate with the remote computing device to use the services of the trained ANNs.

V. Example Operations with Adaptor Networks

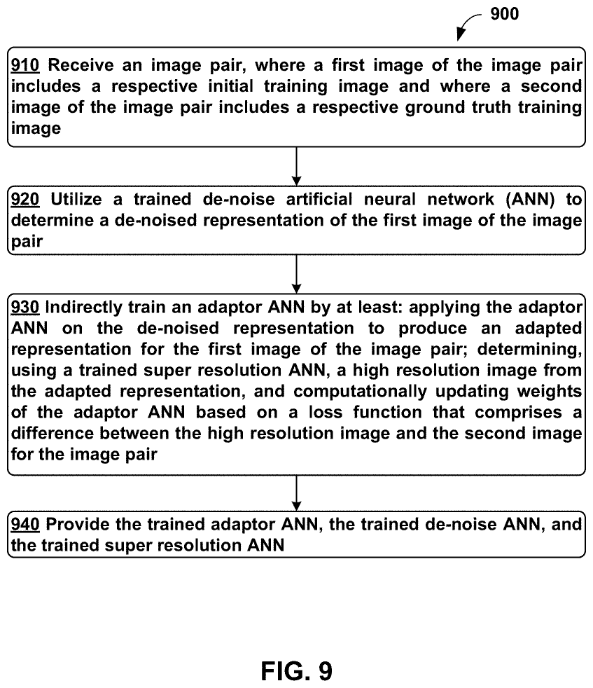

FIG. 9 shows a flowchart for method 900, according to example embodiments. Method 900 can be used for training and utilizing an artificial neural network. Method 900 can be carried out by a computing device, such as computing device 200. However, the process can be carried out by other types of devices or device subsystems. For example, the process could be carried out by a printing device in printing network 100 or a portable computer, such as a laptop or a tablet device.

The embodiments of FIG. 9 may be simplified by the removal of any one or more of the features shown therein. Further, these embodiments may be combined with features, aspects, and/or implementations of any of the previous figures or otherwise described herein

FIG. 9 shows that method 900 can begin at block 910, where the computing device receives an image pair. A first image of the image pair could include a respective initial training image and a second image of the image pair could include a respective ground truth training image.

At block 920, the computing device utilizes a trained de-noise ANN to determine a de-noised representation of the first image of the image pair. In some embodiments, the trained de-noise ANN is disposed on the computing device. In other embodiments, the trained de-noise ANN is disposed on another computing device communicatively connected to the computing device.

At block 930, the computing device indirectly trains an adaptor ANN. The indirect training could include applying the adaptor ANN on the de-noised representation to produce an adapted representation for the first image of the image pair. The indirect training could further include determining, using a trained super resolution ANN, a high resolution image from the adapted representation. The indirect training could yet further include computationally updating weights of the adaptor ANN based on a loss function that comprises a difference between the high resolution image and the second image for the image pair. In some embodiments, the trained super resolution ANN, the trained de-noise ANN, and the adaptor ANN are disposed on the computing device. In other embodiments, the trained super resolution ANN, the trained de-noise ANN, and the adaptor ANN are disposed on another computing device communicatively connected to the computing device.

At block 940, the computing device provides the trained adaptor ANN, the trained de-noise ANN, and the trained super resolution ANN.

In some embodiments, the trained de-noise ANN is trained to receive an input image containing at least some noisy features and correspondingly output a de-noised version of the input image.

In some embodiments, the trained de-noise ANN comprises an input layer, an output layer, and one or more intermediate hidden layers. In such embodiments, the de-noised representation of the first image comprises a feature map generated by an intermediate layer from the one or more intermediate hidden layers. Further, in such embodiments, the intermediate layer may be positioned immediately prior to the output layer.

In some embodiments, the de-noised representation of the first image further includes the feature map concatenated with the first image of the image pair.

In some embodiments, the feature map has more channels than the output layer of the trained de-noise ANN.

In some embodiments, the feature map and an input layer of the adaptor ANN have equivalent dimensions.

In some embodiments, the trained super resolution ANN is trained to receive a low resolution input image and correspondingly output a high resolution version of the low resolution input image.

In some embodiments, the trained super resolution ANN comprises an input layer, an output layer, and one or more intermediate hidden layers. In such embodiments, determining the high resolution image from the de-noised representation may include providing the de-noised representation to an intermediate layer from the one or more intermediate hidden layers; applying at least some of the one or more intermediate hidden layers on the adapted representation; and generating the high resolution image from the output layer. Further, in such embodiments, the intermediate layer may be positioned immediately subsequent to the input layer.

In some embodiments, the intermediate layer has more channels than the input layer of the trained super resolution ANN.

In some embodiments, the intermediate layer and an output layer of the adaptor ANN have equivalent dimensions.

Some embodiments may involve, after indirectly training the adaptor ANN, further training the trained de-noise ANN, the trained adaptor ANN, and the trained super-resolution ANN. This further training may include receiving a second image pair, where a first image of the second image pair includes a respective second initial training image and where a second image of the second image pair comprises a respective second ground truth training image. The further training may also include utilizing the trained de-noise ANN to determine a de-noised representation of the first image of the second image pair. The further training may additionally include applying the adaptor ANN on the de-noised representation to produce a de-noised representation for the second image pair. The further training may yet additionally include determining, using a trained super resolution ANN, a second high resolution image from the de-noised representation for the image pair. The further training may also include computationally updating weights of the trained de-noise ANN, the trained adaptor ANN, and the trained super-resolution ANN based on a loss function that comprises a pixel-wise difference between the second high resolution image for the second image pair and the second image for the second image pair.

In some embodiments, the image pair is part of a plurality of image pairs. In such embodiments, the receiving, the utilizing, and the training in blocks 910, 920, and 930 also apply to each of the plurality of image pairs.

In some embodiments, the providing in block 940 includes providing the trained adaptor ANN, the trained de-noise ANN, and the trained super resolution ANN to a printing device.

In some embodiments, the adaptor ANN includes at least one inception sub-network.

In some embodiments, the second image of the image pair is a high resolution and de-noised version of the first image of the image pair. In other embodiments, the second image of the image pair is a high resolution and noise-free version of the first image of the image pair.

In some embodiments, the difference between the high resolution image for the image pair and the second image for the image pair includes a pixel-wise difference between the high resolution image for the image pair and the second image for the image pair.

VI. Example Image Processing Pipelines with Adapted Loss Functions

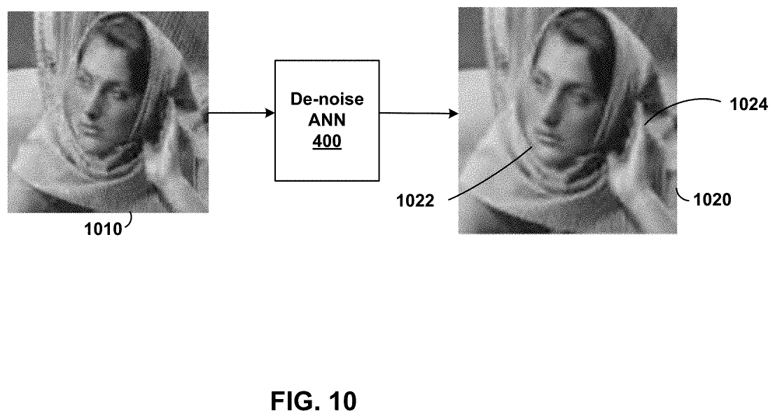

FIG. 10 illustrates an example operation using de-noise ANN 400, according to example embodiments. De-noise ANN 400 may trained to remove/reduce pixel level artifacts in input image 1010 so as to generate output image 1020. In example embodiments, de-noise ANN 400 may be trained to minimize a loss function between pixels from an input training image and pixels in a ground truth image. However, in practice, such pixel-wise loss functions perform poorly when faced with high frequency details, such as texture. For example, using a pixel-wise MSE may encourage de-noise ANN 400 to calculate pixel-wise averages and discourage de-noise ANN 400 from maintaining any extreme pixel values. This leads to dull looking images that do not have rich textures.

For instance, when looking at output image 1020 from de-noise ANN 400, notice how regions 1022 and 1024 are over-smoothed. In particular, at region 1022, it is difficult to differentiate between the woman's face and her clothes. And at region 1024, it is difficult to differentiate between the woman's hand and the background environment. Such overly-smoothed regions could be due to the fact that de-noise ANN 400 does not have training input that helps signify mid-level features in input image 1010.

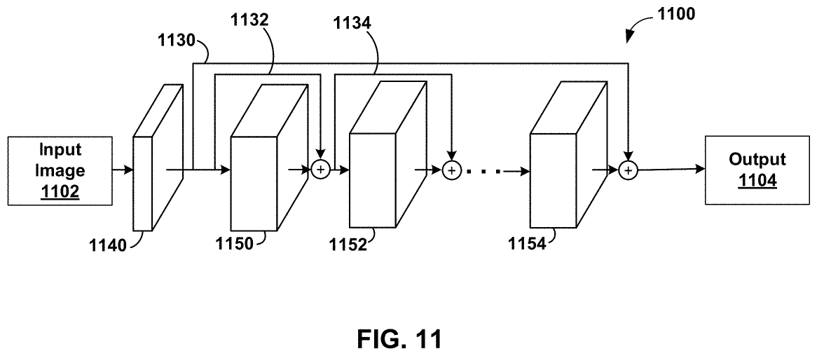

To address this technical problem, the present disclosure provides a training process that utilizes mid-level features (e.g., shapes, textures, perhaps objects) extracted from super resolution ANN 500 to indirectly train de-noise ANN 400 to better understand low level features (e.g., dots, lines, edges) in input images. In examples, various structural modifications may be made to super resolution ANN 500 to facilitate the indirect training of de-noise ANN 400. Such modifications will now be described with respect to FIG. 11.

FIG. 11 depicts modified super resolution ANN 1100, according to example embodiments. Modified super resolution ANN 1100 could be a trained ANN (e.g., a trained machine learning algorithm 340) configured to receive a low resolution input image 1102 and correspondingly generate output 1104, which may be an extracted feature map of the low resolution input image 1102. In example embodiments, modified super resolution ANN 1100 may be a modified version of super resolution ANN 500, as discussed with respect to FIG. 5A. For example, after super resolution ANN 500 is trained (e.g., perhaps using supervised learning pipeline 300, as described above with reference to FIG. 3) various modifications could be made to the structure of super resolution ANN 500 so as to yield modified super resolution ANN 1100. Such modifications are discussed in detail below

As shown in FIG. 11, modified super resolution ANN 1100 includes input layer 1140, intermediate block layers 1150, 1152, and 1154, and various skip connections, including skip connections 1130, 1132, and 1134. In example implementations, input layer 1140 could respectively take the form of input layer 540, intermediate block layers 1150, 1152, and 1154 could respectively take the form of intermediate block layers 550, 552, and skip connections 1130, 1132, and 1134 could respectively take the form of skip connections 530, 532, and 534.

Notice, however, that unlike super resolution ANN 500, modified super resolution ANN 1100 does not include an up-sampling layer nor an output layer (e.g., does not include up-sampling layer 556 or output layer 560). As a result, the output 1104 of modified super resolution ANN 1100 may be a feature map generated by intermediate block layer 1154. In line with the discussion above, the feature map generated intermediate block layer 1154 may have more dimensions (i.e., width*height*depth) than output layer 560, and thus may be a more feature rich representation of input image 1102 than the output from output layer 560 would be.

In an example operating using modified super resolution ANN 1100, low resolution input image 1102 may be received by modified super resolution ANN 1100 at input layer 1140. Input layer 1140 may perform computations (e.g., a series of convolutions, activations, pooling, and/or other operations) on low resolution input image 1102 and provide its results to intermediate block layer 1150. Intermediate block layer 1150 may perform computations on the results from input layer 1140 and provide its results to intermediate block layer 1152. Intermediate block layer 1152 may perform computations on the input from intermediate block layer 1150 and provide its results to intermediate block layer 1154. Intermediate block layer 1154 may perform computations on the input from intermediate block layer 1152 and produce output 1104, which may be an extracted feature map of low resolution input image 1102.

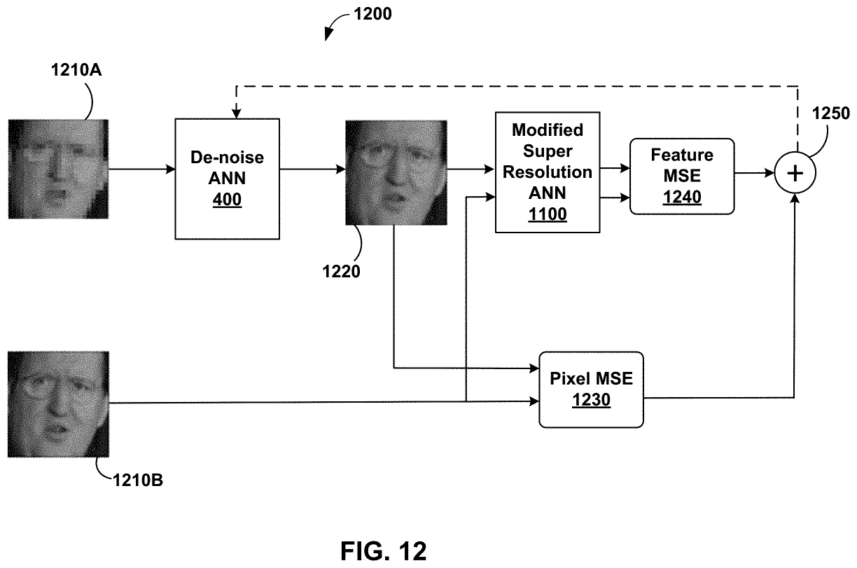

FIG. 12 is a diagram of process 1200 for indirectly training de-noise ANN 400, according to example embodiments. Process 1200 includes de-noise ANN 400 and modified super resolution ANN 1100. Part or all of process 1200 can be implemented by executing software for part or all of process 1200 on one or more processing devices and/or by using other circuitry (e.g., specialized hardware for carrying out part or all of process 1200). Further, part or all of process 1200 could be implemented by a printing device, such as printing device 110 described in reference to FIG. 1.

Process 1200 may begin when training image 1210A is passed to de-noise ANN 400. In line with the discussion above, training image 1210A may be an input image containing at least some noisy features. Training image 1210A may be associated with ground truth image 1210B, which is a de-noised version of training image 1210A. Training image 1210A and ground truth image 1210B may form an image pair.

Upon receiving training image 1210A, de-noise ANN 400 may determine de-noised image 1220, which is a de-noised representation of training image 1210A. After de-noised image 1220 is determined, process 1200 could continue with de-noised image 1220 and ground truth image 1210B both being provided to pixel MSE unit 1230. Upon receiving de-noised image 1220 and ground truth image 1210B, pixel MSE unit 1230 may calculate a difference between de-noised image 1220 and ground truth image 1210B. In some implementations, the difference between de-noised image 1220 and ground truth image 1210B is a pixel-wise difference. That is, pixels in de-noised image 1220 may be compared to corresponding pixels in ground truth image 1210B to determine a pixel-wise MSE value.

At the same time (or at a later time or an earlier time), process 1200 could provide both de-noised image 1220 and ground truth image 1210B to modified super resolution ANN 1100. Upon receiving de-noised image 1220 and ground truth image 1210B, modified super resolution ANN 1100 may determine (i) an extracted feature map for de-noised image 1220 and (ii) an extracted feature map for ground truth image 1210B. In line with the discussion, the extracted feature maps determined by modified super resolution ANN 1100 may be feature maps that are generated by intermediate layer 1154. After modified super resolution ANN 1100 determines those extracted feature maps, process 1200 could continue with the extracted feature maps determined by modified super resolution ANN 1100 being provided to feature MSE unit 1240. Upon receiving the extracted feature maps, feature MSE unit 1240 may calculate a difference between (i) the extracted feature map for de-noised image 1220 and (ii) the extracted feature map for ground truth image 1210B. In some implementations, the difference calculated by feature MSE unit 1240 is a feature map-wise difference. That is, the feature map values for the extracted feature map for de-noised image 1220 may be compared to corresponding feature map values for the extracted feature map for ground truth image 1210B to determine a feature-wise MSE value.

With the pixel-wise MSE value and the feature-wise MSE determined, process 1200 may continue with the pixel-wise MSE value determined by pixel MSE unit 1230 and the feature-wise MSE value determined by feature MSE unit 1240 both being provided to aggregator 1250. Aggregator 1250 may then combine the pixel-wise MSE value and the feature-wise MSE to determine a joint MSE value. In some implementations, aggregator 1250 may apply a scaling factor when determining the joint MSE value. This scaling factor could computationally bias the amount to which the pixel-wise MSE value and the feature-wise MSE value each contribute to the joint MSE value. For example, the scaling factor may be such that the pixel-wise MSE contributes 30% to the joint MSE value while the feature-wise MSE value contributes 70% to the joint MSE value. Other scaling factors are also possible.

Once the joint MSE value is determined, process 1200 can continue by computationally updating the weights of de-noise ANN 400 based on a loss function that utilizes the joint MSE value determined by aggregator 1250.

Process 1200 may continue for a plurality of image pairs. In some embodiments, process 1200 may continue until the occurrence of one or more training termination criteria at de-noise ANN 400. The training termination criteria can include, but are not limited to, when the error determined by the loss function is less than a predetermined threshold value, the change in the error determined by the loss function is sufficiently small between consecutive iterations of training, or a pre-determined maximum number of iterations has been reached, among other possibilities.

Once de-noise ANN 400 is deemed to be trained (e.g., after one or more training termination criteria have been satisfied), the de-noise ANN 400 can be termed a “model” and can generate output predictions based on corresponding inputs. At this point, in some implementations, de-noise ANN 400 (and perhaps super resolution ANN 1100) may be provided to a printing device, such as printing device 110 described in reference to FIG. 1. Upon receiving the trained de-noise ANN 400, the printing device could use the trained ANN to process an image during one or more printing processes. Alternatively, rather than being provided to the printing device, de-noise ANN 400 (and perhaps super resolution ANN 1100) may be provided to a remote computing device commutatively coupled to the printing device. In such a scenario, the printing device may communicate with the remote computing device to use the services of the trained ANN.

VII. Example Operations with Adapted Loss Functions

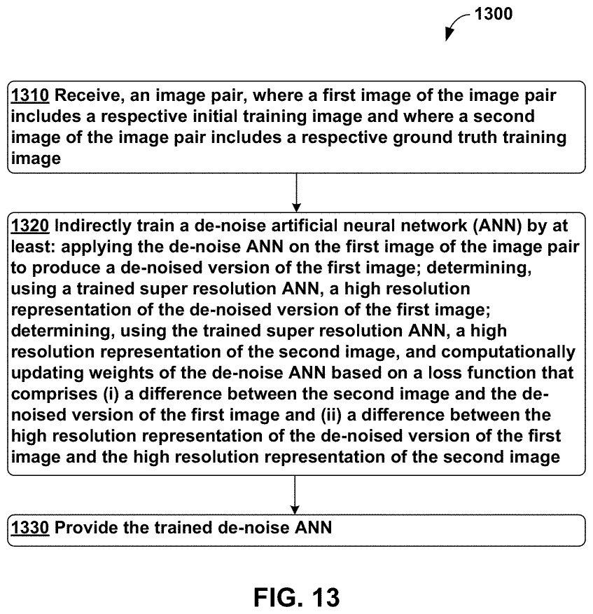

FIG. 13 shows a flowchart for method 1300, according to example embodiments. Method 1300 can be used for training and utilizing an artificial neural network. Method 1300 can be carried out by a computing device, such as computing device 200. However, the process can be carried out by other types of devices or device subsystems. For example, the process could be carried out by a printing device in printing network 100 or a portable computer, such as a laptop or a tablet device.

The embodiments of FIG. 13 may be simplified by the removal of any one or more of the features shown therein. Further, these embodiments may be combined with features, aspects, and/or implementations of any of the previous figures or otherwise described herein

FIG. 13 shows that method 1300 can begin at block 1310, where the computing device receives an image pair. A first image of the image pair could include a respective initial training image and a second image of the image pair could include a respective ground truth training image.

At block 1320, the computing device indirectly trains a de-noise artificial neural network (ANN). The indirect training could include applying the de-noise ANN on the first image of the image pair to produce a de-noised version of the first image. The indirect training could also include determining, using a trained super resolution ANN, an extracted feature map for the de-noised version of the first image. The indirect training could further include determining, using the trained super resolution ANN, an extracted feature map for the second image. The indirect training could yet further include computationally updating weights of the de-noise ANN based on a loss function that comprises (i) a difference between the second image and the de-noised version of the first image and (ii) a difference between the extracted feature map for the de-noised version of the first image and the extracted feature map for the second image.

At block 1330, the computing device provides the trained de-noise ANN.

In some embodiments, the difference between the second image and the de-noised version of the first image includes a pixel-wise difference between the second image and the de-noised version of the first image.

In some embodiments, the trained super resolution ANN is trained to receive a low resolution input image and correspondingly output a high resolution version of the low resolution input image.

In some embodiments, the trained super resolution ANN includes an input layer, an output layer, and one or more intermediate hidden layers. In such embodiments, the extracted feature map for the de-noised version of the first image includes a first feature map generated by an intermediate layer from the one or more intermediate hidden layers, and the extracted feature map for the second image includes a second feature map generated by the intermediate layer. In such embodiments, the difference between the extracted feature map for the de-noised version of the first image and the extracted feature map for the second image includes a difference between the first feature map and the second feature map.

In some embodiments, the trained super resolution ANN includes at least one up-sampling layer between the one or more intermediate hidden layers and the output layer. In such embodiments, the intermediate layer is positioned immediately prior to the up-sampling layer.

In some embodiments, the loss function comprises a scaling factor, the scaling factor computationally biasing an amount to which the difference between the extracted feature map for the de-noised version of the first image and the extracted feature map for the second image contributes to the loss function.

In some embodiments, the image pair is part of a plurality of image pairs. In such embodiments, the receiving and the training from blocks 1310 and 1320 also apply to each of the plurality of image pairs.

In some embodiments, wherein the providing comprises providing the indirectly trained de-noise ANN to a printing device.

In some embodiments, the second image of the image pair comprises a de-noised version of the first image of the image pair.

VIII. Conclusion

The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A computer-implemented method comprising:
receiving, at a computing device, an image pair, wherein a first image of the image pair comprises a respective initial training image and wherein a second image of the image pair comprises a respective ground truth training image;
utilizing, by the computing device, a trained de-noise artificial neural network (ANN) to determine a de-noised representation of the first image of the image pair;
indirectly training, by the computing device, an adaptor ANN by at least:
applying the adaptor ANN on the de-noised representation to produce an adapted representation for the first image of the image pair;
determining, using a trained super resolution ANN, a high resolution image from the adapted representation, and
computationally updating weights of the adaptor ANN based on a loss function that comprises a difference between the high resolution image and the second image for the image pair; and
providing, using the computing device, the trained adaptor ANN, the trained de-noise ANN, and the trained super resolution ANN.

2. The computer-implemented method of claim 1, wherein the trained de-noise ANN is trained to receive an input image containing at least some noisy features and correspondingly output a de-noised version of the input image.

3. The computer-implemented method of claim 1, wherein the trained de-noise ANN comprises an input layer, an output layer, and one or more intermediate hidden layers, and wherein the de-noised representation of the first image comprises a feature map generated by an intermediate layer from the one or more intermediate hidden layers.

4. The computer-implemented method of claim 3, wherein the intermediate layer is positioned immediately prior to the output layer.

5. The computer-implemented method of claim 3, wherein the de-noised representation of the first image further comprises the feature map concatenated with the first image of the image pair.

6. The computer-implemented method of claim 3, wherein the feature map has more channels than the output layer of the trained de-noise ANN.

7. The computer-implemented method of claim 3, wherein the feature map and an input layer of the adaptor ANN have equivalent dimensions.

8. The computer-implemented method of claim 1, wherein the trained super resolution ANN is trained to receive a low resolution input image and correspondingly output a high resolution version of the low resolution input image.

9. The computer-implemented method of claim 1, wherein the trained super resolution ANN comprises an input layer, an output layer, and one or more intermediate hidden layers, and wherein determining the high resolution image from the adapted representation comprises:
providing the adapted representation to an intermediate layer from the one or more intermediate hidden layers;
applying at least some of the one or more intermediate hidden layers on the adapted representation; and
generating the high resolution image from the output layer;

10. The computer-implemented method of claim 9, wherein the intermediate layer is positioned immediately subsequent to the input layer.

11. The computer-implemented method of claim 9, wherein the intermediate layer has more channels than the input layer of the trained super resolution ANN.

12. The computer-implemented method of claim 9, wherein the intermediate layer and an output layer of the adaptor ANN have equivalent dimensions.

13. The computer-implemented method of claim 1, further comprising:
after indirectly training the adaptor ANN, further training the trained de-noise ANN, the trained adaptor ANN, and the trained super-resolution ANN by at least:
receiving a second image pair, wherein a first image of the second image pair comprises a respective second initial training image and wherein a second image of the second image pair comprises a respective second ground truth training image;
utilizing the trained de-noise ANN to determine a de-noised representation of the first image of the second image pair;
applying the adaptor ANN on the de-noised representation to produce an adapted representation for the second image pair;
determining, using a trained super resolution ANN, a second high resolution image from the adapted representation for the image pair, and
computationally updating weights of the trained de-noise ANN, the trained adaptor ANN, and the trained super-resolution ANN based on a loss function that comprises a pixel-wise difference between the second high resolution image for the second image pair and the second image for the second image pair.

14. The computer-implemented method of claim 1, wherein the image pair is part of a plurality of image pairs, and wherein the receiving, the utilizing, and the indirect training also apply to each of the plurality of image pairs.

15. The computer-implemented method of claim 1, wherein the providing comprises providing the trained adaptor ANN, the trained de-noise ANN, and the trained super resolution ANN to a printing device.

16. The computer-implemented method of claim 1, wherein the adaptor ANN comprises at least one inception sub-network.

17. The computer-implemented method of claim 1, wherein the second image of the image pair is a high resolution and de-noised version of the first image of the image pair.

18. The computer-implemented method of claim 1, wherein the difference between the high resolution image for the image pair and the second image for the image pair comprises a pixel-wise difference between the high resolution image for the image pair and the second image for the image pair.

19. A computing device, comprising:
one or more processors; and
non-transitory data storage storing at least computer-readable instructions that, when executed by the one or more processors, cause the computing device to perform tasks comprising:
receiving an image pair, wherein a first image of the image pair comprises a respective initial training image and wherein a second image of the image pair comprises a respective ground truth training image;
utilizing a trained de-noise artificial neural network (ANN) to determine a de-noised representation of the first image of the image pair;
indirectly training an adaptor ANN by at least:
applying the adaptor ANN on the de-noised representation to produce an adapted representation for the first image of the image pair;
determining, using a trained super resolution ANN, a high resolution image from the adapted representation, and
computationally updating weights of the adaptor ANN based on a loss function that comprises a pixel-wise difference between the high resolution image and the second image for the image pair; and
providing the trained adaptor ANN, the trained de-noise ANN and the trained super resolution ANN.

20. An article of manufacture comprising non-transitory data storage storing at least computer-readable instructions that, when executed by one or more processors of a computing device, cause the computing device to perform tasks comprising:
receiving an image pair, wherein a first image of the image pair comprises a respective initial training image and wherein a second image of the image pair comprises a respective ground truth training image;
utilizing a trained de-noise artificial neural network (ANN) to determine a de-noised representation of the first image of the image pair;
indirectly training an adaptor ANN by at least:
applying the adaptor ANN on the de-noised representation to produce an adapted representation for the first image of the image pair;
determining, using a trained super resolution ANN, a high resolution image from the adapted representation, and
computationally updating weights of the adaptor ANN based on a loss function that comprises a pixel-wise difference between the high resolution image and the second image for the image pair; and
providing the trained adaptor ANN, the trained de-noise ANN, and the trained super resolution ANN.
